(19) United States
(12) Patent Application Publication
(10) Pub. No.: US 2025/0206322 A1
(43) Pub. Date: Jun. 26, 2025

(54) Method and Device for Operating a Vehicle

(71) Applicant: Daimler Truck AG, Leinfelden-Echterdingen (DE)

(72) Inventors: Tobias AURAND, Freiberg (DE); Markus ZIMMER, Leinfelden-Echterdingen (DE)

(21) Appl. No.: 18/852,159

(22) PCT Filed: Feb. 2, 2023
(86) PCT No.: PCT/EP2023/052510

§ 371 Date: Sep. 27, 2024

(30) Foreign Application Priority Data
Mar. 29, 2022 (DE) 10 2022 107 335.1

(51) Int. Cl. B60W 50/02; B60W 50/035; B60W 50/14

(52) U.S. Cl. CPC B60W 50/0205; B60W 50/035; B60W 50/14; B60W 2050/146; B60W 2510/101; B60W 2520/10; B60W 2540/16

(57) ABSTRACT

A method for operating a vehicle includes monitoring the vehicle for an occurrence of predefined critical error functions, in a case of which, without a predefined reaction of a vehicle driver, it is necessary to deactivate the vehicle and/or to prevent a reactivation of the vehicle after it has come to a standstill. When an occurrence of one of the predefined critical error functions is established, determining whether the vehicle has come to a standstill, and when it has, starting a predefined time period and checking whether the predefined reaction takes place. After the predefined time period, deactivating the vehicle and/or preventing the reactivation of the vehicle when the predefined reaction has not taken place. From a start of the predefined time period, outputting information to the vehicle driver relating to the predefined time period, the deactivating and/or the preventing the reactivation of the vehicle, and the predefined reaction.

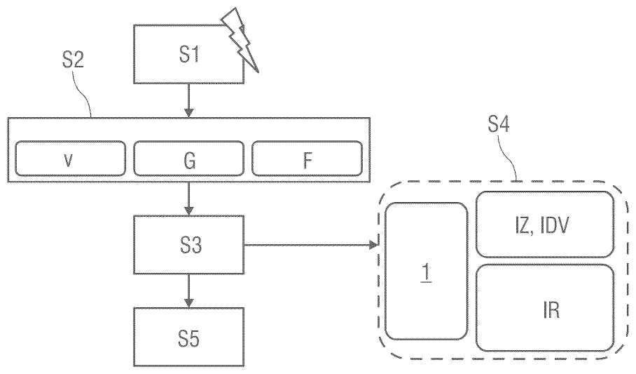

### BACKGROUND AND SUMMARY OF THE INVENTION

The invention relates to a method and a device for operating a vehicle.

A method is known from the prior art, as described in FR 3 098 481 A1, for signalling a hazard to the driver of a motor vehicle. The method detects a hazardous situation that is likely to affect the vehicle. The driver's reaction is monitored. The transmission of a warning message corresponding to the detected hazardous situation is adapted according to the driver's reactions.

CN 112109542 A describes a control system for a power take-off of a utility vehicle.

A control system of a freewheel mode for a hybrid vehicle with an internal combustion engine switched off is known from EP 2 620 339 B1.

The object of the invention is to specify a method and device for operating a vehicle that are improved in relation to the prior art.

In a method according to the invention for operating a vehicle, the vehicle is monitored for an occurrence of predefined critical error functions, in the case of which, without at least one predefined reaction of a vehicle driver, it is necessary to deactivate the vehicle and to prevent a reactivation of the vehicle after it has come to a standstill. If an occurrence of one of these predefined critical error functions is established, it is checked whether the vehicle has come to a standstill. If it is determined that the vehicle has come to a standstill, a predefined time period is started. During the predefined time period, it is checked whether the at least one predefined reaction of the vehicle driver takes place. After the predefined time period has elapsed, the vehicle is deactivated and/or the reactivation of the vehicle is prevented if the at least one predefined reaction of the vehicle driver has not taken place during the predefined time period. From the start of the predefined time period, information is output to the vehicle driver, in particular via at least one output unit of the vehicle, relating to the predefined time period, relating to the resulting deactivation and/or prevention of the reactivation of the vehicle after the predefined time period has elapsed, and relating to the required at least one predefined reaction of the vehicle driver.

A device according to the invention for operating the vehicle is designed and configured to carry out this method. In particular, the device has at least one processing unit which is designed and configured:
to monitor the vehicle for the occurrence of the predefined critical error functions, in the case of which, without at least one predefined reaction of the vehicle driver, it is necessary to deactivate the vehicle and/or to prevent the reactivation of the vehicle after it has come to a standstill,
to check, if the occurrence of one of these predefined critical error functions is established, whether the vehicle has come to a standstill,
if it is determined that the vehicle has come to a standstill, to start a predefined time period and to check during the predefined time period whether the at least one predefined reaction of the vehicle driver takes place,
to deactivate the vehicle and/or prevent reactivation of the vehicle after the predefined time period has elapsed and the at least one predefined reaction of the vehicle driver has not been taken place during the predefined time period,
to generate, from the start of the predefined time period, the outputting of the information to the vehicle driver relating to the predefined time period, relating to the resulting deactivation and/or prevention of the reactivation of the vehicle after the predefined time period has elapsed, and relating to the required at least one predefined reaction of the vehicle driver.

The device can also have a plurality of processing units, each of which are designed and configured to perform one or more of these tasks, with each of these tasks then being performed by at least one of the processing units.

Furthermore, the device has in particular the at least one output unit to output the information to the vehicle driver relating to the predefined time period, relating to the resulting deactivation and/or prevention of the reactivation of the vehicle after the predefined time period has elapsed and relating to the required at least one predefined reaction of the vehicle driver.

The predefined reaction of the vehicle driver is in particular an action which the vehicle driver must perform to prevent the vehicle from being deactivated and/or reactivated, for example an action to rectify the error function or an action which makes it possible to operate the vehicle in an emergency operating mode for example, at least to a limited extent even with this error function, in which in particular one or more vehicle functions are only available to a limited extent, and/or for a limited time and/or for a limited travelling distance. Preventing the reactivation of the vehicle means, in particular, definitively parking the vehicle, for example at least for a predefined period of time within which a vehicle state can return to normal by the vehicle coming to a standstill, thereby eliminating the critical error function, and/or until one or more predefined vehicle parameters are within predefined limits again, and/or until a repair has been carried out, and/or until the reactivation is authorized by an authorized entity. This authorized entity is, for example, a manufacturer of the vehicle, a vehicle workshop that has been authorized in particular by the manufacturer, a vehicle mechanic that has been authorized in particular by the manufacturer and/or by the vehicle workshop, and/or a vehicle dealer that has been authorized in particular by the manufacturer.

The vehicle is, for example, a utility vehicle, in particular a heavy goods vehicle, or a passenger car. For example, the vehicle is an electric vehicle. It has, in particular, a high-voltage system with at least one electric drive engine for driving the vehicle. Such a high-voltage system works, for example, with a DC voltage of greater than 60 V and/or with an AC voltage of greater than 30 V. Compared to vehicles with an internal combustion engine, such electric vehicles presuppose that the vehicle driver has new knowledge about vehicle behaviour and how the individual components interact. In particular, there can be significant differences in the way electric vehicles and internal combustion engine vehicles handle critical error functions that occur. The solution according to the invention is particularly advantageous in the case of electric vehicles, since during the operation of such vehicles with a high-voltage system, the above-described critical error functions can occur when the vehicle is driving, in which case it is advantageous or necessary, in particular for safety reasons, to prevent the vehicle from restarting, and therefore continuing to drive, when it is parked.

Without the solution according to the invention, in such a case the vehicle would not inform the vehicle driver that the detected critical error function results in this vehicle behaviour and that it is not possible to continue driving after coming to a standstill, in particular after certain standstill conditions have been reached. This vehicle behaviour would therefore leave the vehicle driver confused. The only way for the vehicle driver to find out about the state of the vehicle would be to consult the vehicle's very comprehensive user manual, also known as a vehicle handbook. The vehicle driver could gather information therefrom about the possible critical error functions and appropriate ways to handle them, but this would be very laborious and particularly time-consuming. Owing to the lack of information about the vehicle behaviour and possible ways to handle it, in particular in a timely manner, without the solution according to the invention, it would therefore be considerably more difficult to initiate countermeasures to prevent the vehicle from coming to a halt, in particular in an unfavourable position.

Owing to the solution according to the invention, this problem of the vehicle driver lacking information and in particular also the insufficient communication between the vehicle and the vehicle driver is solved, for example, by displaying to the vehicle driver on a display unit, for example an onboard display of the vehicle, a time frame, i.e., the time period until the vehicle will definitively be switched off, i.e., until the deactivation and/or prevention of reactivation, and the resultant consequences. In addition, recommended actions are displayed to the vehicle driver by an automatic output of information, in particular by an automatic display on the display unit, designed as an onboard display for example, i.e., information about at least one reaction required of the vehicle driver, for example by displaying an appropriate page of the user manual. As a result, the vehicle driver is able to take countermeasures, i.e., perform the at least one predefined reaction. This can prevent the vehicle from coming to a complete halt, for example, or can at least prevent the vehicle from coming to a halt at an unfavourable position. In addition, owing to the solution according to the invention, the behaviour of the vehicle is explained to the vehicle driver in a logical manner.

The solution according to the invention therefore comprises in particular an intelligent output concept, in particular a display concept, by means of which the vehicle can be prevented from coming to a halt, in particular in an unfavourable position, in the event of the occurrence of a critical error function. Owing to the solution according to the invention, the vehicle driver is made aware, in particular by the information provided thereby, of the consequences of the present situation and is specifically enabled via the information output, in particular via the display in the onboard display, to take countermeasures, i.e., to carry out the predefined reaction, in particular action, expected of them before a reactivation of the vehicle is prevented. As a result, the vehicle driver at least has the option of selecting a parking location for their vehicle in a particularly favourable and safe place.

The solution according to the invention makes it possible in particular to improve an interaction between vehicle and vehicle driver in the event of an occurrence of such a critical error function. Because of the output concept according to the invention, in particular display concept, in particular by displaying a running timer or countdown, the vehicle driver is made aware of the vehicle behaviour and the consequences of the situation and is able to understand internal processes, for example in software that determines the method sequence. This can stop the vehicle driver from getting frustrated with the vehicle, which can happen if the driver does not understand what is occurring. The vehicle supports the vehicle driver in a targeted manner by automatically outputting, in particular displaying, relevant information if an error occurs.

In one possible embodiment of the method, it is provided that the information is output on an output unit, designed as a display unit, of the vehicle, for example, as already mentioned above, on the onboard display of the vehicle. It is accordingly provided in one possible embodiment of the device for carrying out the method that the output unit is designed as such a display unit. The display unit is in particular a multimedia display unit. By way of example, it also has at least one loudspeaker. The above-described information that is output to the vehicle driver can be displayed on the display unit by means of text, numbers, images and/or pictograms, for example. It is provided in particular that even sections, for example one or more pages, of the vehicle user manual can be displayed. The time period can be displayed to the vehicle driver in the form of the above-mentioned timer or countdown for example, i.e., for example in the form of a displayed counting down to zero or counting up to a displayed end value, and/or graphically, for example in the form of a bar extending up to an end point or reducing to zero or in the form of a circle that goes from a full circle to zero, or a circle that forms. This makes it possible to output comprehensive information quickly and easily to the vehicle driver.

In one possible embodiment of the method, it is therefore provided that the information relating to the predefined time period is output as a timer or countdown, for example in the manner described above. As an alternative or in addition, it can therefore be provided in one possible embodiment of the method that the information relating to the required at least one predefined reaction of the vehicle driver is output by displaying a section from the user manual of the vehicle that describes this at least one predefined reaction of the vehicle driver.

Whether the vehicle has come to a standstill is checked in particular on the basis of predefined standstill conditions. In this case, it is provided in particular that it is determined that the vehicle has come to a standstill only if all of the predefined standstill conditions have been met. It is provided in particular that it is determined that the vehicle has come to a standstill only if the following predefined standstill conditions are met: that a current speed of the vehicle is 0 km/h and a gear selector lever of the vehicle is in a neutral position or a park position and a hand brake of the vehicle is activated. In particular, this prevents the above-described consequences, i.e., the deactivation of the vehicle and/or the prevention of the reactivation, from occurring for example while the vehicle is travelling or if the vehicle stops briefly, for example due to traffic, in particular while the vehicle is still on a roadway. This prevents the safety of the vehicle and vehicle driver and of other road users from being impaired, in particular due to the risk of a collision.

These three standstill conditions are, at least with very high probability, only met in combination with one another if the vehicle is parked away from the roadway or has to be stationary for a very long time on the roadway due to traffic, for example in a traffic jam or at a traffic light with a very long red phase. Therefore, if these three standstill conditions are met, it can be assumed that the vehicle has parked at a safe parking location where hazards, in particular the risk of a collision, for the vehicle driver and the vehicle and for other road users are minimized, or that other road users have at least noticed the vehicle parked in this way and are therefore not surprised by the stationary vehicle. The above-mentioned gear selector lever is, for example, a selector lever for engaging a gear stage of a power transmission of a drive train of the vehicle and/or a selector lever for selecting a driving mode of the vehicle, in particular forward drive or reverse drive. In a neutral position or a park position, neither a forward drive nor a reverse drive of the vehicle is possible; in particular, it is not possible to transmit any force from the drive engine(s) of the vehicle to the wheels of the vehicle.

In one possible embodiment of the device, it is provided that the at least one processing unit and/or the output unit are coupled to a CAN (controller area network), also referred to as a CAN bus, of the vehicle. This makes it possible, for example, for the processing unit and/or the display unit to be notified about the critical error function, for example by transmitting a corresponding error code via the CAN, for example from another component of the vehicle in which the critical error function has occurred or which has determined the critical error function. This component is, for example, a control unit of the vehicle.

In one possible embodiment of the device, it is provided that the at least one processing unit and the output unit are designed as a joint unit. By way of example, the above-mentioned onboard display, in particular multimedia onboard display, of the vehicle is designed as both a display unit and a processing unit. This avoids having to install a plurality of additional components in the vehicle for carrying out the method, and instead the display unit alone for example, in particular the onboard display, is already sufficient. In this case, for example, an onboard display already provided in the vehicle anyway can be used or a conventional onboard display provided anyway can be replaced by the onboard display provided for carrying out the method.

Exemplary embodiments of the invention are explained in more detail hereinbelow with reference to a drawing.

### BRIEF DESCRIPTION OF THE DRAWING

The FIGURE schematically shows a sequence of a method for operating a vehicle.

### DETAILED DESCRIPTION OF THE DRAWING

The FIGURE shows a schematic illustration of a method for operating a vehicle.

In a first step S1 of the method, the vehicle is monitored for an occurrence of predefined critical error functions, in the case of which, without at least one predefined reaction of a vehicle driver, it is necessary to deactivate the vehicle and/or to prevent a reactivation of the vehicle after it has come to a standstill.

If the occurrence of one of these predefined critical error functions is established, as illustrated schematically in the FIGURE by an error function symbol in the first step S1, it is checked in a second step S2 whether the vehicle has come to a standstill. For this purpose, it is checked in the example shown whether predefined standstill conditions have been met. The vehicle is determined to have come to a standstill in the example shown if, as predefined standstill conditions, a current speed v of the vehicle is 0 km/h, a gear selector lever G of the vehicle is in a neutral position or a park position and a hand brake F of the vehicle is activated.

If the vehicle is determined to have come to a standstill, a predefined time period is started in a third step S3, in particular a timer or countdown set to the predefined time period, and during the predefined time period it is checked whether the at least one predefined reaction of the vehicle driver takes place.

In a fourth step S4, from the start of the predefined time period, information IZ relating to the predefined time period, information IDV relating to the resulting deactivation and/or prevention of the reactivation of the vehicle after the predefined time period has elapsed and information IR relating to the required at least one predefined reaction of the vehicle driver is output by means of an output unit 1 to the vehicle driver.

This output unit 1 is designed in particular as a display unit, in particular as a multimedia output unit, in particular as a multimedia onboard display of the vehicle. The information IZ relating to the predefined time period is output, for example, as a timer or countdown, displayed in particular on the display unit. The information IR relating to the required at least one predefined reaction of the vehicle driver is output, for example, by displaying a section of a user manual of the vehicle describing this at least one predefined reaction of the vehicle driver.

In a fifth step S5, after the predefined time period has elapsed, the vehicle is deactivated and/or the reactivation of the vehicle is prevented if the at least one predefined reaction of the vehicle driver has not taken place during the predefined time period. In other words, this fifth step S5 only takes place in this case and can therefore be avoided by the predefined reaction of the vehicle driver, in particular by the vehicle driver performing a predefined action.

A device for operating the vehicle is designed and configured to carry out this method. It comprises in particular at least one processing unit for carrying out the described steps S1 to S5, with at least the output of the above-described information IZ, IDV, IR to be output being generated in the fourth step S4, and the output unit 1. By way of example, the at least one processing unit and the output unit 1 are designed as a joint unit.

The solution described is or thus comprises in particular a method in which, in the event of various critical error functions occurring, processes occurring in the vehicle are made clear to the vehicle driver after the standstill conditions have been reached, the vehicle driver is notified of a remaining time frame within which they can avoid consequences that are explained to them, and at the same time the vehicle driver is shown suitable alternative actions, i.e., they are given information IR about the reaction expected of them in order to avoid these consequences. This can prevent, in particular, the vehicle from coming to a halt at an unfavourable position. This also stops the vehicle driver from getting frustrated about incomprehensible vehicle behaviour, since the vehicle behaviour is explained to the vehicle driver by the solution described, in particular the output of the information.

The output unit 1, in particular the multimedia onboard display, is provided for example as an additional interface in the vehicle for the information output and interaction between the vehicle and the vehicle driver. It is provided in particular that this output unit 1 can access the CAN of the vehicle.

The method is summarized once more hereinbelow. After the occurrence of the critical error function and once the defined standstill conditions have been reached, information is output to the vehicle driver on the output unit 1 designed in particular as a multimedia onboard display, this information being the information IZ about the predefined time period, in particular as a running timer, i.e., countdown, the information IDV about the possible ensuing consequences, i.e., relating to the resulting deactivation and/or prevention of the reactivation of the vehicle after the predefined time period has elapsed, and the information IR relating to the required at least one predefined reaction of the vehicle driver, the latter in particular as suitable alternative actions. As a result, the vehicle driver is able to prevent the vehicle from being definitively switched off, i.e., from being deactivated and/or prevented from being reactivated.

By way of example, in the event of the occurrence of the predefined critical error function, a resulting error code is sent via the CAN, and thereafter the standstill conditions are checked for in order to establish whether the vehicle is at a standstill.

If the standstill conditions have been met, the predefined time period of, for example, 10 seconds starts, the end of which initiates the final shutdown of the vehicle, i.e., the deactivation, and therefore prevents the vehicle from being restarted, i.e., reactivated. The vehicle driver is made aware of this by the described information output, in particular via the output of the counting-down timers or countdowns and via the output of the consequence, i.e., the deactivation and/or prevention of the reactivation of the vehicle. In order to avoid this consequence, the vehicle driver is additionally shown the information IR relating to their required predefined reaction, for example in the form of alternative possible actions, so as to be able to take countermeasures. This is done, for example, by automatically displaying the appropriate section, for example appropriate pages, in the user manual.

1.-10. (canceled)

11. A method for operating a vehicle, comprising the steps of:
monitoring the vehicle for an occurrence of predefined critical error functions, in a case of which, without at least one predefined reaction of a vehicle driver, it is necessary to deactivate the vehicle and/or to prevent a reactivation of the vehicle after it has come to a standstill;
when an occurrence of one of the predefined critical error functions is established, determining whether the vehicle has come to a standstill;
when it is determined that the vehicle has come to the standstill, starting a predefined time period and, during the predefined time period, checking whether the at least one predefined reaction of the vehicle driver takes place;
after the predefined time period has elapsed, deactivating the vehicle and/or preventing the reactivation of the vehicle when the at least one predefined reaction of the vehicle driver has not taken place during the predefined time period; and
from a start of the predefined time period, outputting information (IZ, IDV, IR) to the vehicle driver relating to the predefined time period, relating to the deactivating and/or the preventing the reactivation of the vehicle after the predefined time period has elapsed, and relating to the at least one predefined reaction of the vehicle driver.

12. The method according to claim 11, wherein the information (IZ, IDV, IR) is output on a display unit (1) of the vehicle.

13. The method according to claim 11, wherein the information (IZ) relating to the predefined time period is output as a timer or countdown.

14. The method according to claim 11, wherein the information (IR) relating to the at least one predefined reaction of the vehicle driver is output by displaying a section from a user manual of the vehicle that describes the at least one predefined reaction of the vehicle driver.

15. The method according to claim 11, wherein it is determined that the vehicle has come to the standstill when the following predefined standstill conditions have been met:
a current speed (v) of the vehicle is 0 km/h;
a gear selector lever (G) of the vehicle is in a neutral position or a park position; and
a hand brake (F) of the vehicle is activated.

16. A device for operating a vehicle, wherein the device is configured to perform the method according to claim 11.

17. The device according to claim 16, comprising:
a processing unit configured to:
monitor the vehicle for an occurrence of predefined critical error functions, in a case of which, without at least one predefined reaction of a vehicle driver, it is necessary to deactivate the vehicle and/or to prevent reactivation of the vehicle after it has come to a standstill;
determine, when an occurrence of one of the predefined critical error functions is established, whether the vehicle has come to the standstill;
when it is determined that the vehicle has come to the standstill, to start a predefined time period and to check during the predefined time period whether the at least one predefined reaction of the vehicle driver takes place;
deactivate the vehicle and/or prevent reactivation of the vehicle after the predefined time period has elapsed and the at least one predefined reaction of the vehicle driver has not taken place during the predefined time period; and
generate, from a start of the predefined time period, an outputting of information (IZ, IDV, IR) to the vehicle driver relating to the predefined time period, relating to a deactivation and/or a prevention of a reactivation of the vehicle after the predefined time period has elapsed, and relating to the at least one predefined reaction of the vehicle driver;
and comprising an output unit (1) to output the information (IZ, IDV, IR) to the vehicle driver relating to the predefined time period, relating to the deactivation and/or the prevention of the reactivation of the vehicle after the predefined time period has elapsed, and relating to the at least one predefined reaction of the vehicle driver.

18. The device according to claim 17, wherein the output unit (1) is a display unit.

19. The device according to claim 17, wherein the processing unit and/or the output unit (1) is/are coupled to a controller area network of the vehicle.

20. The device according to claim 17, wherein the processing unit and the output unit (1) are configured as a joint unit.
